(19) United States
(12) Patent Application Publication
(10) Pub. No.: US 2018/0211214 A1
(43) Pub. Date: Jul. 26, 2018

(54) SYSTEMS AND METHODS FOR COMPILATION AND DISTRIBUTION OF AIR CARGO SECURITY INFORMATION

(71) Applicant: WISETECH GLOBAL LIMITED, Alexandria, New South Wales (AU)

(72) Inventors: Angela Gadaev, Alexandria, New South Wales (AU); Sarah White, Alexandria, New South Wales (AU); Marek Przybyl, Alexandria, New South Wales (AU); Igor Nuzhnov, Alexandria, New South Wales (AU); Richard White, Alexandria, New South Wales (AU)

(21) Appl. No.: 15/744,023

(22) PCT Filed: Jul. 15, 2016
(86) PCT No.: PCT/AU2016/050622

§ 371 Date: Jan. 11, 2018

(30) Foreign Application Priority Data
Jul. 16, 2015 (AU) 2015902822

(51) Int. Cl. G06Q 10/08

(52) U.S. Cl. CPC G06Q 10/0832; G06Q 10/0833

(57) ABSTRACT

The disclosed systems and methods provide security for goods during transport and can help generate necessary customs and other government forms based on the requirements for each country or jurisdiction into which the cargo shipment travels during transport. Declarations forms customized to the cargo shipment and based on the individual requirements of the countries can be generated along with guides to help inspect the goods, provide a secure chain of custody for the goods, and manage cargo with multiple shipments.

### CROSS-REFERENCE TO RELATED APPLICATIONS

The present application claims priority from Australian Provisional Patent Application No 2015902822 filed on 16 Jul. 2015, the content of which is incorporated herein by reference.

### TECHNICAL FIELD

Disclosed are systems and methods for compilation and distribution of air cargo security information.

### BACKGROUND

The movement of physical goods is a cornerstone upon which the modern economy is built. In today's geopolitical climate, the movement of goods is a heavily regulated industry, with the security of the shipments a particular point of emphasis. Countries want assurance that the entering goods are as listed and that the shipment was secured so as to prevent any nefarious activities. Consignees and carriers want similar assurances that the shipment they are receiving and carrying is as declared and expected.

There are two main ways of assuring security of a shipment, screening and a trusted supply chain entity. Screening is the inspection of the shipment to ensure that the shipment is as declared and that no shipment tampering has occurred. A trusted supply chain entity is a system of approved vendors who adhere to outlined procedures designed to ensure that the consignment is not tampered with as it moves through various shipping processes.

The air transport industry is particularly concerned with shipment security. An industry association, the International Air Transport Association (IATA), develops and recommends industry standards for its members to follow regarding shipment security.

Assurance of shipment security can be particularly difficult for freight forwarders. Freight forwarders are entities that handle the transport of goods on someone's behalf. This can include transport of the goods from a customer's location to the freight forwarder's location and the distribution of goods from the freight forwarder's location. To better utilize allocated space and optimize costs, the freight forwarders may consolidate a number of customers' shipments to a specific location to receive a discounted shipping rate from carriers. The commingling of customer's shipments increases the difficulty of secure shipment assurance since not all of the items within the shipment traveled the same path.

There exists a need in the transport industry for a system that can easily and accurately generate and transmit a master security declaration, taking into account the individual security status of the elements of the shipment.

### SUMMARY

Disclosed is a process for security validation of a consignment including collecting security related data from a database and visually presenting it in an embedded form into a system of freight forwarding, the embedded form being mandatorily required depending upon the jurisdiction of the origin or transhipment location of a consignment, wherein the embedded form includes available fields for identifying logistics service providers who deliver goods to freight forwarders, logistics service providers having associated security details. If the form is mandatorily required, accessing from a database of logistics service providers the details including security details of at least one particular logistics service provider associated with the particular consignment, and providing the security details of the particular logistics service providers to the form and if the security details of the particular logistics service provider associated with a particular consignment security details are faulty, issuing an alert. If the form is not mandatorily required, and instructions are received to generate the form, accessing from a database of logistics service providers, the details including security details of at least one particular logistics service provider associated with the particular consignment, and providing the security details of the particular logistics service provider to the form. If the security details of a particular logistics service provider associated with a particular consignment security details are faulty, issuing an alert. Moreover disclosed is that if the security details of one or more particular logistics service providers are faulty, issuing an alert stipulating security inspection process or defining grounds for security inspection exemption of the goods by one of the methods recognised by the jurisdiction of the origin or transhipment location of the consignment and recording the outcome on the form. Also disclosed is if the security details of one or more particular logistics service providers are not faulty or appropriate security measures are taken and recorded on the form, generating the form to electronically dispatch it with a way-bill or any other logistics documents. Also disclosed are like systems for security validation of a consignment.

Also disclosed is a supply chain security system including a database that stores information compiled about trusted entities that transport goods and a processor configured to upon receipt of a request from a user, query the database for at least some portion of information about at least one of the trusted entities associated with a cargo shipment determine if the trusted entities associated with the cargo shipment meet requirements recognized by the jurisdiction of the origin or a transshipment location of the cargo shipment at each transit point along a transit pathway for the cargo shipment, verify that the cargo shipment is secure. If the cargo shipment is determined to be unsecure, at least one of generate an alert to inspect the cargo shipment and prevent further transit of the cargo shipment. Also disclosed is that the processor is further configured to generate a security declaration form when the cargo shipment is verified to be secure at any of the transit points along the transit pathway before it is handled to the next logistics service provider in the supply chain.

Also disclosed is a shipping security method including a manner in which to receive a request for information about at least one entity in a group of trusted entities, where at least one entity is associated with a cargo shipment and determine if the trusted entity meets requirements recognized by the jurisdiction of the origin or transshipment location of the cargo shipment and at each transit point along a transit pathway for the cargo shipment, verify that the cargo shipment is secure and if the cargo shipment is determined to be unsecure, generate an alert to inspect the goods before permitting the cargo shipment to be moved to a next transit point.

Also disclosed is a security validation system for a consignment including an application having an embedded freight forwarding form with data pre-populated and optionally edited by an operator and validated against relevant business rules to facilitate the compliance to jurisdiction of the location of the form issuer, the embedded form being mandatorily required depending upon a jurisdiction of an origin and/or a transit point of the consignment, wherein the embedded form includes available fields for identifying logistics service providers who deliver goods to freight forwarders, logistics service providers having associated security details and a processor configured to receive a request to provide security details related to the consignment, correlate the requested security details to at least one of a consignment, a chain of custody, and a logistics service provider related to the consignment, in response, provide security details related to the consignment and if a declarations form is required for a geographic location, generate a security declaration form customized to the geographic location based at least in part on the provided security details related to the consignment.

Also disclosed is a goods inspection system method including identifying information about a cargo shipment that includes at least one of an origin or, transit points along a transit pathway for the cargo shipment, determining at least one security inspection or exemption from inspection requirements for the cargo shipment based at least in part on the identified information about the cargo shipment, querying a security inspection methods database (or data storage) for information relating to the at least one inspection requirement and generating an alert containing guidance for the cargo shipment with recommendations to the query for information relating to at least one security inspection requirement.

Also disclosed is a cargo shipping method including receiving multiple cargo shipments wherein the multiple cargo shipment is made up of one or more portions of the cargo shipment, correlating at least some portions of the cargo shipment based on types of goods, inspection requirements for the cargo and security information determined by trusted entities involved in the supply chain of this consignment, wherein trusted entities are verified and a security declaration is be provided in accordance with the verified trusted entities and compiling the multiple cargo shipments into a consolidated shipment at least based on the correlated security information about the correlated portion of the cargo shipment.

### Definitions

An embedded form when invoked produces the security declaration form compiled in accordance with IATA Recommended Practice 1630 Cargo Security other practice. Any other type of form is within the scope of this disclosure.

A form issuer is a freight forwarder/the user of the Freight Management & Logistics Computing System, issuing air waybill and security declaration, the supply chain stakeholder currently handling the cargo;

A chain of custody is a supply chain stakeholders/logistics service providers who handle cargo shipment along the supply chain;

A consignment is a cargo shipment, a set of goods destined for delivery to someone;

A transit pathway is a supply chain, the sequence of processes involved in delivery of consignment;

A transit point is a point along the supply chain where consignment handling is passed from one supply chain stakeholder to another;

Security related data is data required to complete security declaration form;

A logistics service provider is a supply chain stakeholder (could be a shipper, freight forwarder, carrier, transporter, warehouse, ground handler, etc.). Perhaps we should use “supply chain stakeholder” term instead, this is the term used by IATA and sounds a bit clearer;

Security information is the same as security related data;

Security details is the same as security information;

faulty security details are either a mal-formatted, missing or expired trusted entity identifier or incorrect or missing security inspection method or exemption, leading to consignment being treated as ‘unsecure’;

An alert can be represented as a warning or error icon and shows a tooltip when user hovers the pointer over this icon without clicking it, a “hover box” with information about the item being hovered over;

An untrusted rating status is gained by a consignment with faulty security details, requiring the consignment to be security inspected by the form issuer (supply chain stakeholder handling the cargo) or (depending on the context) refers to supply chain stakeholder which is not known to/registered by a jurisdiction of the geographical location of the form issuer;

An expired trusted rating status is gained by a previously trusted entity when the validity date of their security registration with a jurisdiction of their geographical location is earlier than the date of the consignment's departure from this geographical location;

A trusted entity is a supply chain stakeholder known to or registered with a jurisdiction of their geographical location and their registration is up to date;

Validated means that an item is checked for errors including mal formatted, invalid or missing information according to relevant business rules;

Relevant business rules include an application defined and coded set of rules that applies to data captured on the form in accordance to the functional business requirements in order to facilitate the compliance to security jurisdiction requirements of the geographic location of the form issuer;

Exemption from inspection requirements applies to a consignment with a commodity exempt from security inspection even if handled by an entity with untrusted rating as approved by a jurisdiction of a location of the form issuer, the exemption code instead of an inspection code in this case must be stated on the security declaration form;

Security method database is the same as security inspection method database—a list of security inspection or screening methods stored in the database on per country basis and used for retrieval by the application or the form issuer;

Security inspection requirement can depend on the type of inspection or whether due to untrusted rating or expired trusted rating and may include requirement to perform security inspection by one of the methods from the security inspection method database.

### BRIEF DESCRIPTION OF DRAWINGS

FIG. 1 shows an example shipment module that is integrated into a larger freight management and logistics system;

FIG. 2 shows an example air cargo message that is generated based on information stored in the freight management and logistics computing system;

FIG. 3 depicts various trusted entities and their relationships to shippers, carriers and freight forwarders;

FIG. 4 shows an example system in which shippers, carriers, and freight forwarders are able to access the trusted entities in the freight management system;

FIG. 5A shows an example security declaration form;

FIG. 5B shows the data included to the message is customized to the e-CSD form and its requirements in various countries;

FIG. 6 depicts the embedded form and the visualization of the data to the user; and

FIG. 7 is a flowchart of the disclosed method.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

### DESCRIPTION OF EMBODIMENTS

The systems and methods described below assist in compiling relevant shipment information regarding the security status of a shipment and preparing the necessary security declarations in accordance with relevant rules and regulations. The system can be integrated into, interface with or exist independently of a larger freight management and logistics system. The process for security validation of a consignment includes collecting security related data from a database and visually presenting it in an embedded form into a system of freight forwarding, the embedded form being mandatorily required depending upon the jurisdiction of the origin or transhipment location of a consignment, wherein the embedded form includes available fields for identifying logistics service providers who deliver goods to freight forwarders, logistics service providers having associated security details. If the form is mandatorily required, accessing from a database of logistics service providers the details including security details of at least one particular logistics service provider associated with the particular consignment, and providing the security details of the particular logistics service providers to the form and if the security details of the particular logistics service provider associated with a particular consignment security details are faulty, issuing an alert.

The embedded form provides visualization of the data to the user. The form can be displayed using various technologies, including but not limited to .NET WinForm user control to display this information in CargoWise One or use XAML for GLOW or HTML to display an information in a web page or iOS for iPhone or Android controls for Android devices. This is an electronic form with information pre-populated with the data stored within the internal database or electronically retrieved from an external data source and partially available for edit by an operator. The data captured on the form can be persisted in a database and stored for later retrieval. The data can be validated for accuracy and legitimacy to satisfy security compliance requirements. The validated data can be printed or electronically sent to an interested party (this being an airline or any other external party's computer system or an internal data buss for usage by other logistics components/modules of our software) in a format required by a receiving application.

The disclosed systems for compiling and distributing secure shipment data and/or information can be integrated or can interface with a larger shipping and logistics system. This allows information to flow between the systems, easing the user burden to provide information to prepare requisite documentation (in either paper or electronic form) for the any aspect of the shipping process, including, for example, air cargo shipment. The two systems can share a single database, exist as two or more databases that are in electronic communication with one another, exist as a system of distributed databases, as in a cloud computing system, or other suitable integrated database configuration.

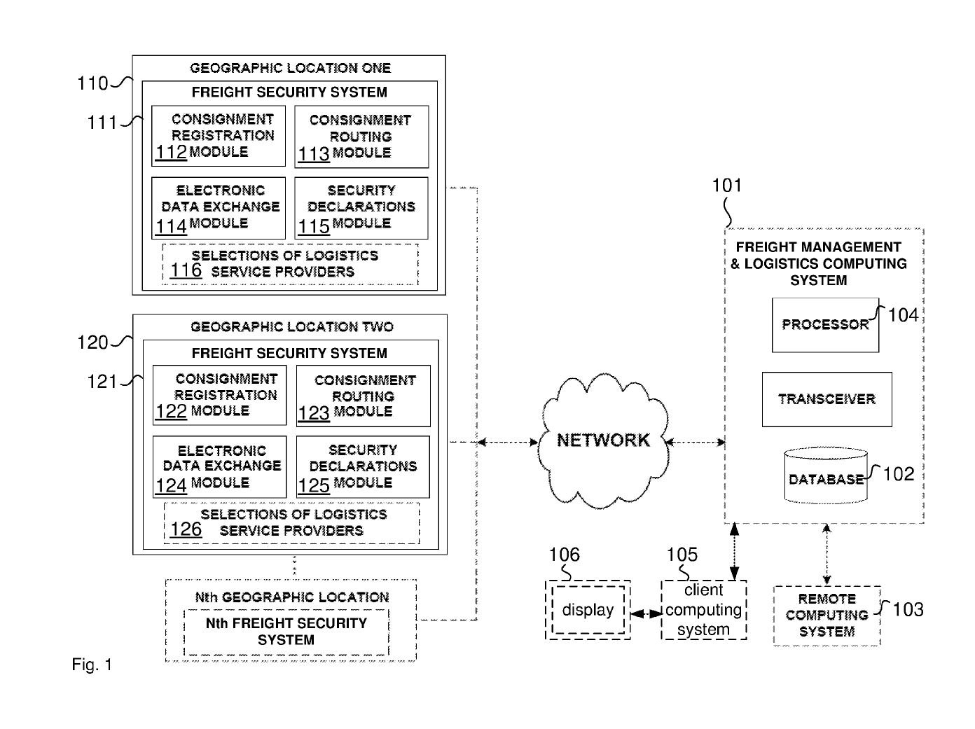

FIG. 1 shows an example shipment module 101 that is integrated into a larger freight management and logistics system. Multiple geographic locations 110/120 each have a freight security system 111/121. Each freight security system has various modules, such as the consignment registration module 112/122, the consignment routing module 113/123, the electronic data exchange module 114/124, and the security declarations module 115/125. Provided can be a selection of service providers 116/126 (carriers, transporters, depots, and the like). Other modules can be added, as desired. A module is part of a more complex structure. A module can be an independent unit of a dependent unit. A module can be individually developed and later linked to the more complex structure.

The consignment registration module 112/122 can prompt a user, such as freight forwarders, shippers, freight consolidators or agents handling the goods to be shipped, to enter information about the type and quantity of goods that are being shipped, names and addresses of supply chain stakeholders, etc. The consignment routing module 113/123 can prompt a user, such as the shippers, carriers, and freight forwarders handling the goods to be shipped, to enter information about the destination for the goods and any other information about the shipping pathway from the intake point for the goods to the final destination. The electronic data exchange facility module 114/124 can prompt a user, such as carriers and freight forwarders handling the goods along the path to next in the supply chain stakeholder, to enter information and confirm that a transfer of the goods was done under secure conditions and no suspicion of tampering occurred. The electronic data exchange module 114/124 can also be a supply chain security module that verifies the security of the goods at each point along the supply/shipping chain.

The security declarations module 115/125 can generate various government forms and other import/export declarations for the goods moving into and out of a country. The generated security declarations can be customized to each port and can be automatically generated based on data stored or entered into another module. Additional optional features include a selection(s) of carrier(s) and/or freight forwarder(s) module 116/126 prompts users, such as shippers and other carriers and freight forwarders to enter information about another carrier, warehouse or freight forwarders that is requested or required along the shipping pathway.

As is described in detail below, if there are any issues security details of a logistics service provider the system will indicate or alert. In particular, the security details of a logistics service provider may be faulty. There could be other security problems as well as described below. In such a case, if not remedied otherwise, the goods must be inspected or other relevant action must be taken before they can proceed along the supply chain. A consequence is that inspections mid-path in the shipping of goods is both time-consuming and expensive so issuing an indication or alert is preferably avoided. For example, if the goods or any aspect of the shipping of the goods are found not to comply with any required regulations along the shipping path, heavy fines or additional inspection fees may be imposed on any one or more of the shippers, the carriers, the freight forwarders, and/or the receivers of the goods.

If an indication or alert is issued or under other circumstances, an inspection according to a particular jurisdiction or country may take place. Inspections can differ in each jurisdiction or country. For a particular cargo shipment, with known origin and transit points, a guide or set of inspection recommendations can be generated for the cargo shipment based on known inspection requirements in the jurisdictions and/or countries through which the goods travel. Further, the inspection recommendations can help prepare any carrier, freight forwarder, or the like along the supply chain for the inspection of the goods while the goods are in the control of the carrier or freight forwarder. Any suitable recommendations, guides, and preparation can be done for the inspections and any suitable analyzed data, generated reports and recommendations, alerts, and the like can be created and associated with the cargo shipment to be inspected.

### The System Database

The system 101 includes a database 102 that can store configured information for use in accordance with the disclosed systems and methods for compilation and distribution of air cargo security information such as country or region regulation and law regarding security of a shipment, consignors and associated security credentials and information, and other relevant shipment security information.

The database or portions of the database 102 can be stored locally to the system 101, such as on a server, stored remotely and accessed across a network or stored in a cloud-based computing system 103. The use of a cloud-based computing system and/or remote storage of the database on a network system allows multiple users to access the relevant information stored on the database 101.

Additionally, database updates are easily and readily accessible to the users. The information on the database can be updated by a vendor, user or other. The updated information can be accessible immediately or can be held for review before being accessible on the database. Holding the updated information for review can allow a database administrator to validate the updated information to ensure data and format correctness.

A hierarchal permissions structure can be implemented in the database updating process, which would allow the various system users to have predetermined levels of ability to update the database 103. While a lower level user could update information such as addresses, a higher-level user can update information such as laws or regulations.

In an embodiment of the system 101, a system vendor can maintain and update the system database as a value added service to system customers. Selected portions of the information on the database 102 can be restricted to selected customers, i.e. only customers requiring or requesting access to the information. Alternatively, the database 102 can be open, allowing all the users and/or customers access to any of the information of the database. Privacy concerns can necessitate the redaction or restriction of information, or portions thereof, to predetermined or preselected users.

Further, the database 102 can be updated with information from the larger freight and logistics system. The information can be pushed from the larger system or pulled from the larger system by the security system. Alternatively, if the systems are integrated, the database 102 can be a shared database that stores the relevant information and can be accessed and updated by both systems.

The system 101 further includes a processor 104 that controls the communications with the freight security systems 111/121 and queries database 102 for required security declarations, except goods, trusted providers, accepted inspections and other supply chain related data. For example, database 102 may be an SQL database and processor 104 may execute an SQL query on database 102. Other non-relational databases may equally be used.

A client computing system 105 is also connected to management and logistics system 101. The client computing system 105 may be a mobile device, such as phone or tablet, or other computing device including desktops and laptops. The client computing system 105 is connected to or is integrated with a display device 106. The client computing system 105 may be located at each of multiple freight forwarding companies while the management and logistics system 101 may be a single system centrally located and serving all clients. In one example, client computing device 105 is connected to the management and logistics system 101 via the internet. Client computing module 105 may also be integrated with the freight security systems 111/121 in the sense that each freight security system 111/121 is connected to a respective display similar to display 106.

In one example, client computing system 105 has software installed thereon that generates a user interface on display 106 including one or more embedded forms. In this example, client computing system 105 requests security related data from database 102 by sending a request message to management and logistics system 101 and pre-populates the embedded form with the security related data received from the management and logistics system 101. A user of the client computing device 105 can then easily see the security related information without manually entering it.

The embedded form includes available fields for security details, such being pre-populated for identifying logistics service providers who deliver goods to freight forwarders, logistics service providers having associated security details. Client computing system 105 then determines whether the embedded form is mandatorily required. To that end, client computing system 105 determines the jurisdiction of the origin or transhipment location of a consignment. Database 102 stores the specific requirements and rules of each jurisdiction so client computing system 105 can send a request message to the management and logistics system 101. Management and logistics system 101 returns the requirements to the client computing system 105.

If the form is mandatorily required, client computing system 105 queries a database of logistics service providers, such as warehouse operators and truck companies. From that database, client computer system 105 accesses the details including security details of the logistics service provide associated with the particular consignment. Client computing system 105 then provides the retrieved security details to the form. This way, the form is automatically filled in with the details from service providers for the entire supply chain from the warehouse to the airplane, for example.

However, it is possible that the security details are faulty. In that case, the security details should be rectified before a security declaration form is issued. Therefore, client computing system 105 determines if the security details of the logistics service provider are faulty. Faulty is at least one of an untrusted rating, mal-formatted, missing or expired trusted entity identifier or incorrect or missing security inspection method or exemption.

Client computing system 105 then issues an alert in the pre-populated embedded form that is visually presented on display 106. The alert indicates that the security details are faulty. Further, if the embedded form is mandatory and the security details are faulty, client computing system obstructs the issuance of a security declaration form until the faulty security details are rectified. For example, client computing system 105 deactivates an click button labelled ‘issue form’, such as by changing the colour to grey or by creating a pop-up window when the user attempts to issue the security declaration form. The pop-up window may contain an indication of which security details are faulty so that the user can rectify them.

Finally, the client computing system 105 issues the security declaration if the faulty security details are rectified. It is noted that due to the direct connection to the database 102, the information pre-populated in the form can be automatically updated when the security information on database 102 is updated. As a result, the security declaration form can issue without further user interaction because the faulty security information can be rectified automatically. In that sense, there may be a large number of consignments that each have the same faulty security details, such as where the trusted entity status of a truck company has expired. All these consignments are now ‘on hold’ and no security declaration form is issued. Once the truck company renews their trusted entity status, all security declarations can issue automatically and almost instantaneously without any user interaction.

It is noted that instead of using an installed software application, the client computing system 105 may access a service hosted by the management and logistics system 101, such as a Software as a Service (SaaS). In that case, processor 104 of management and logistics system 101 performs the steps that are performed by client computing system 105 in the above description. In this sense, processor 104 generates the embedded form as HTML code and makes the HTML code accessible to a browser application of client computer system 105. The display and interaction with the form may also comprise AJAX functions based on JavaScript and XMLHttpRequest or Silverlight applications.

The steps above may be performed by modules or other means within a corresponding computer system. This includes software means such as functions, classes, code files, libraries or objects as well as service means including middleware services connected by a message passing architecture. In other examples, means include hardware means, such as virtual machines, web servers, ASICs, FPGAs, CPUs and GPUs.

### Air Cargo Message Generation

In order to facilitate an efficient and effective transfer of air cargo information between the various air cargo handling entities, such as freight forwarders and carriers, IATA developed the standard cargo interchange message procedure (Cargo-IMP). Each air cargo shipment can have such a message, which includes relevant information regarding the cargo, such as space allocation, the air waybill and other pertinent information. Space allocation is a part of consolidation process. When multiple shipments are consolidated in order to be transported together for better space utilization and cost reduction. An air waybill is issued for consolidated cargo, i.e. consignments have to be consolidated first, and only then the air waybill is issued. Having a standardized format allows the various cargo handling entities to easily and readily know the relevant information regarding the air cargo. IATA introduced a new message format, Cargo-XML, which includes the same pertinent information regarding the air cargo.

The system can distribute the compiled shipment security information in either of the standard message formats for air cargo transportation, Cargo-IMP or Cargo-XML. The security information is appended or included in the message, allowing carriers, country customs officials and others to quickly and easily obtain necessary information regarding the air cargo. The generation and inclusion of the air cargo security information by the system reduces the amount of paperwork required while shipping the air cargo, reduces the potential for data errors and increases efficiency as the information can be quickly and easily read by the required parties.

The distributed air cargo security information is compiled by the system using the shipment information and various database resources.

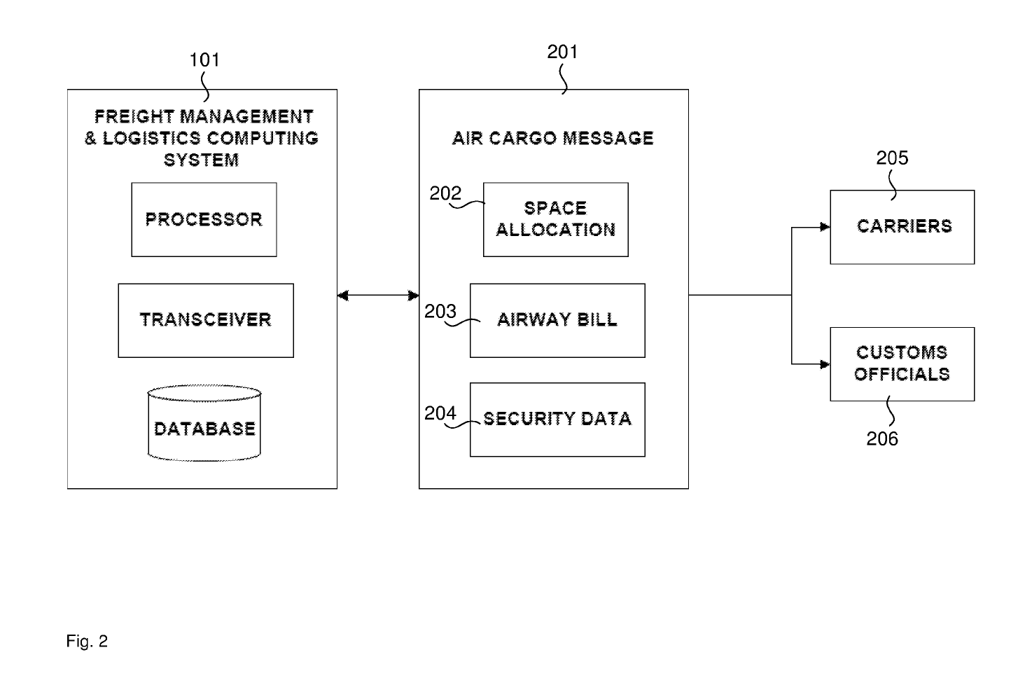

FIG. 2 shows an example air cargo message 201 that is generated based on information stored in the freight management and logistics computing system 101. The air cargo message 201 includes information about the shipment's space allocation 202, airway bill 203, and security data 204, as discussed above. The air cargo message 201 can be transmitted to any person or entity, including carriers 205 and customs officials 206, as noted in FIG. 2. Any suitable number of air cargo message can be generated for any shipment.

### Trusted Entities

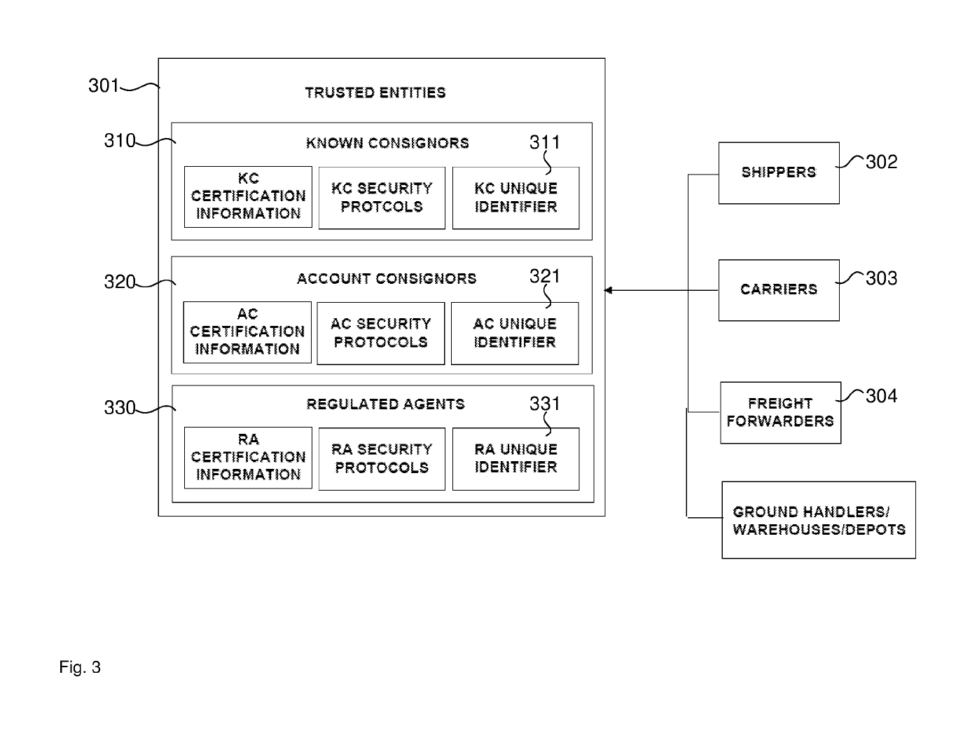

FIG. 3 depicts various trusted entities 301 and their relationships to shippers 302, carriers 303 and freight forwarders 304. Many countries have instituted a procedure by which consignors can acquire a known consignor (KC) 310 status, which is a trusted entity status. That is, the consignor has successfully demonstrated to an issuing authority that they have developed a security plan and taken the necessary procedures and steps to ensure that their distribution of goods is secure from production to when the goods have left the consignor's secured facility. KC's 310 are often required to renew their certification on a regular and ongoing basis to ensure that the necessary security protocols are current and in-place to ensure integrity of air cargo leaving a KC's facility.

Another trusted entity status is an account consignor (AC) 320, which is similar to the KC status. However, the air cargo from an AC is only cleared to fly on non-passenger aircraft without further cargo screening procedures. Again, as with the KC status, the AC status typically requires regular renewal.

Regulated agents (RA) 330 are another trusted entity status of the air cargo industry. Regulated agents 330 acquire the status from an issuing authority by demonstrating, like the KC status, they have and have implemented a security plan to ensure the integrity of air cargo during their care. RAs are often subject to renewal requirements in a similar manner to the KCs. RAs can be freight forwarders, airlines, air transport services or other air cargo handling entities.

The air cargo security information system 101 can store relevant information regarding trusted entities 301 in the database 102, which can include the unique identification number 311/321/331 of the trusted entity. Many countries and jurisdictions require each trusted entity to have a unique identification number 311/321/331 that is put on forms or in air cargo messages to confirm or inform of the identification of the trusted entity. Other trusted entity information can also be stored, such as contact information and the designated security personnel for each of the trusted entities.

The regulations regarding the above trusted entity statuses, KC, AC and RA, can be different from country to country and one or more of the entity statuses may not be reciprocated in some countries. The system database 102 stores the current status of each trusted entity for each country in each physical location that the trusted entity has a conferred status. The system 101 can monitor the status of each trusted entity to ensure that the status is still valid and trusted. Should an entity's regulated status change or lapse, the database 102 can be updated to reflect the new information so that cargo security processing is done correctly and efficiently. Further, the system can notify or alert a user that an entity's regulated status is due for renewal. The user can then notify the trusted entity so that appropriate action can be taken before the loss of the trusted entity status.

Alternatively, the system 100 can directly notify or alert the trusted entity regarding entity status expiration. Should the trusted entity have an interface with the overall freight and logistics system or the air cargo security information system, the alert or notice can be sent through such system. If the trusted entity is not interfaced with either system, the air cargo security system can generate and transmit an outgoing message to the trusted entity using information from the database, such as an email or physical address.

Air cargo originating from a trusted entity, such as a KC 310 or AC 320, can be handled by a RA 330, who facilitates the transfer of the air cargo from the trusted entity to a carrier such as an airline or air transport service. The use of trusted entities throughout the process until the cargo is boarded onto a plane ensures the integrity and security of the air cargo, thereby allowing the cargo to bypass standard screening procedures.

In some countries or jurisdictions, air cargo originating from a non-trusted entity can be secured by a RA 330, if the RA 330 subjects the air cargo to known and approved inspection or screening procedures. The inspections or screenings performed by an RA 330 can add to the total overall cost of shipping the air cargo. However, this is a necessary expense, as most countries or jurisdictions require that all air cargo be secured before being boarded. The requisite inspection or screening procedures may differ based on the aircraft type, passenger or cargo aircraft onto which the air cargo is to be boarded.

FIG. 3 shows an example system in which shippers, carriers, and freight forwarders are able to access the trusted entities in the freight management system. Each entity, the KCs, the ACs, and the RAs, has respective certification information, security protocols, and unique identifiers, in this example. The shippers, carriers, and freight forwarders about able to access, retrieve, and rely upon the verified information.

### Air Cargo Contents

A listing of the contents of a particular air cargo shipment is often required, not only for the air cargo security declaration, but also for any waybill associated with the shipment. The contents of the air cargo shipment can be input into the database 102 by a user, or can be retrieved from the database if previously entered by a user or other, such as a consignor.

In the case of freight forwarders, acting as an RA, they might consolidate a number of consigned shipments into a larger air cargo. The consolidation of air cargo is a standard industry practice as it allows for more efficient and economical shipment of the goods. Freight forwarders may distribute a consigned shipment to a number of staging locations where the various portions can be consolidated into other air cargo shipments for delivery to a number of final destinations. Depending on the ultimate destination of a shipment, the consigned shipment, or portions thereof, may be staged at a number of locations in order to achieve an optimal overall economical and/or efficient shipping process. As discussed herein, it is important that regulated agents or other entities responsible for the air cargo know the previous security status of the air cargo in order to reaffirm or deny the integrity or security of the air cargo.

To affirm the security of a consolidated air cargo shipment, the trusted entity conferring or assuring such a security status, must ensure that the various pieces of air cargo of the consolidated shipment have a valid security status. That is, each individual shipment that is included in the consolidated shipment must have a valid security status in order for the overall consolidated shipment to have a security status conferred. In an example consolidated shipment, if the various individual shipments all came from various KC's, the RA could confirm that the overall consolidated shipment is secure and can bypass screening and inspection procedures.

For air cargo shipment consolidators, the air cargo security information system can store the security status for the individual shipments. Once a consolidated air cargo shipment is compiled, the system can check the security status of the various included shipments to ensure that they comply with air cargo security regulations. Once confirmed, the consolidated air cargo shipment can be confirmed as a secure shipment.

Each time the air cargo is transferred between trusted entities, the transferring party is often required to affirm the integrity of the shipment. If the transferring party cannot do so, the air cargo reverts to an unsecured shipment and may require an inspection or screening procedure to reconfirm the security of the air cargo before it can be boarded onto an aircraft.

As part of the improved Cargo-IMP and Cargo-XML messaging standards, the security history of an air cargo shipment can be queried. This allows a regulatory agency, such as a customs or inspections agency, a carrier, such as an airline or air transport company, or others to view the history of the air cargo shipment and check the security status of the shipment at any point. A country's regulatory agency can request such information to ensure that the security status conferred on an air cargo at any point complies with that country's particular rules or regulations regarding air cargo security.

The listing of goods is also important as certain good types are exempt from inspection. Various air transport regulatory bodies, both national and international, can have listings of exempted good types. The system can store the various exempted good types and their associated regulatory body in the system database. This information allows the system to generate the air cargo security declaration accurately and can assist the user or system in consolidation shipments, taking into account the security status of the included various individual shipments that comprise the consolidated shipment.

### Air Cargo Transit

Another aspect of air cargo security is the origin, destination and any known transfer or transit points of the air cargo. This information can be input into the air cargo security system or the air cargo security system can retrieve the information from a database or other stored location.

Transfer points are locations where the air cargo may be transferred to another aircraft on its way to the final destination. Transit points are locations where the air cargo may sit idle on an aircraft while on its way to the final destination, and may not require any additional security measures taken. If the cargo is unloaded from an aircraft and re-consolidated by a freight forwarder on its shipping pathway to destination at a transshipment point prior to being loaded to another aircraft, the necessary security measures in accordance with the jurisdiction of the transshipment point location may take place. Transshipment points are locations where cargo has already left an origin country and being re-handled by logistics service providers on its way to the final destination.

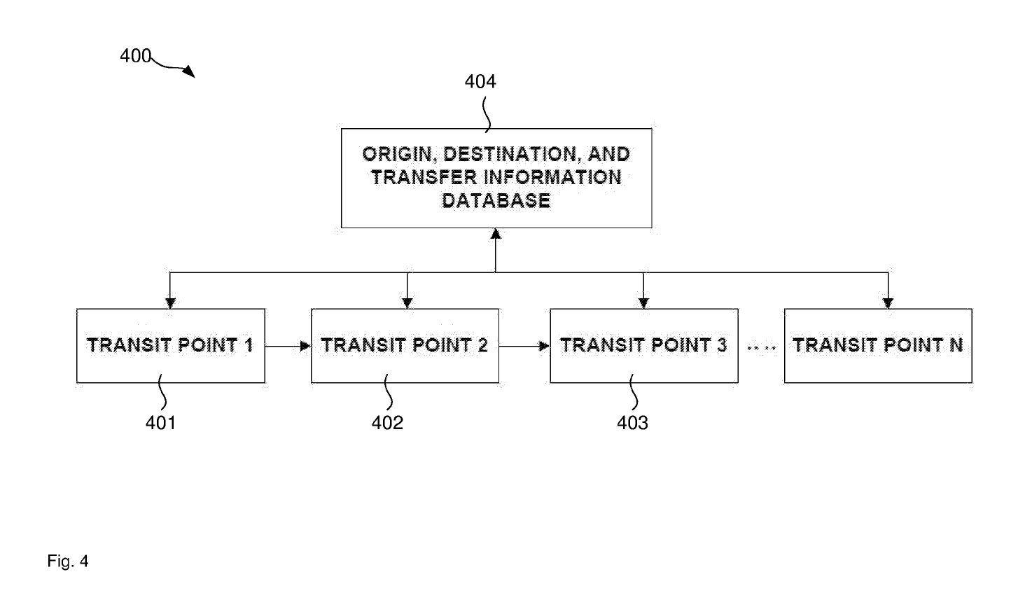

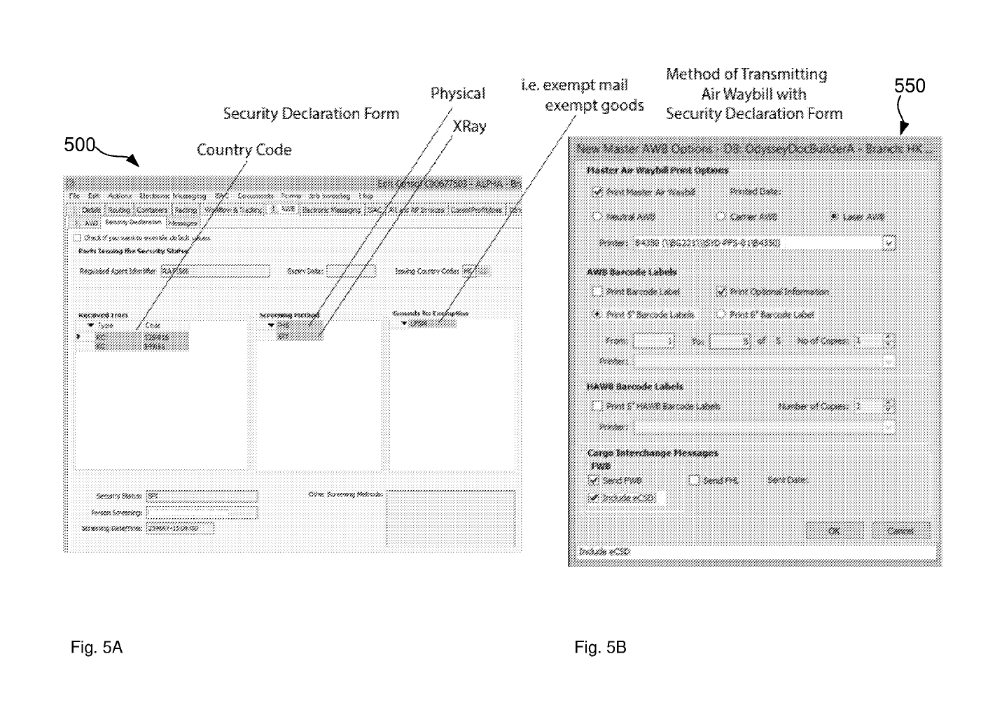

FIG. 4 shows a cargo pathway 400 with three transit points along the way 401, 402, 403. At each transit point 401, 402, 403, the carrier and/or freight forwarder is able to access the information stored in the origin, destination, and transfer database 404 about the goods being shipped. Likewise, the carriers and freight forwarders are able to input information about the goods into the origin, destination, and transfer database 404 at their respective transit points. Any suitable number of transit points can be included and have access to either retrieve or store information in the origin, destination, and transfer information database 404.

The origin of the shipment is important as this is often the departure point at which the air cargo boards an aircraft. The air cargo security is governed by the rules and regulations of the air cargo departure location.

By knowing the departure location of an air cargo shipment, the system can apply air cargo security regulations, both country specific and general international, to the air cargo shipment. This allows the user to ensure compliance of the air cargo shipment with the pertinent regulations. If there is a conflict between the air cargo shipment and the rules and regulations, the user can be alerted to such a conflict by the system. The system can then present the user various option to correct or bypass the conflict warning.

If the air cargo underwent screening at any point that information can be input into the system as part of the security history. In the case of initially unsecured air cargo, the air cargo is required to undergo screening in order to be secured and allowed to board an aircraft. The screening method employed for the air cargo might not be acceptable in certain departure countries or jurisdictions. The system can check the screening method used for the air cargo to ensure compliance with the rules and regulations of the air cargo departure location.

In an example situation, an unsecured cargo undergoes a screening in order to become secured and allowed to board an aircraft. A freight forwarder may transfer that air cargo to an interim location before dispatching the cargo to a final destination. Before departing the interim location, the air cargo is required to comply with the rules and regulations of the interim location. Countries have differing standards regarding screening methods that can be employed to secure the cargo. If the initial screening method does not comply with the requirements of the interim location, the cargo can be required to undergo an approved screening method. The systems and methods as described herein provide for alert or notification to a user if such a situation can happen given the various parameters regarding the air cargo and its security. The air cargo security system can alert a user that the previously used screening method does not comply with the rules and regulations and the system can provide the user options regarding the shipment, such as an approved screening method, or other suitable and compliant options.

### Security Declaration

International regulations mandate that cargo transported on aircraft be accompanied with documentation regarding the security of the cargo. In order to assist the industry in complying with such regulations, IATA has developed standardized forms, including the consignment security declaration (CSD). This form contains relevant security information regarding the air cargo, including how the cargo was secured, when the cargo was secured and who secured the cargo. For each air cargo shipment, the CSD provides an auditable history of the security of the shipment.

Typically the CSD is a physical paper that is completed and travels with the air cargo. The physical nature of the document can cause information inaccuracies due to incorrect transcription of the requisite data and the document itself can be damaged or destroyed in transit. To increase efficiency of the air transport system, IATA has introduced an electronic version of the CSD (e-CSD). The e-CSD can be included in the freight waybill (FWB) or the electronic air waybill (e-AWB) using the standard electronic cargo message, Cargo-IMP and Cargo-XML. Inclusion of the e-CSD in the electronic cargo message increases air transport efficiency by reducing the need for paperwork, providing a quick and readily accessible history of cargo security and allowing for easy and accurate transmission of information to the relevant parties.

The air cargo security information system can compile and/or generate the CSD and output the resulting document in an e-CSD or physical paper format. The preparation of the CSD by the air cargo security system can occur as an automatic process during generation of a waybill for the air cargo or can be initiated by a user as part of the air cargo processing procedure. Relevant and requisite information for inclusion in the CSD is retrieved from the database by the system and compiled. If additional information is required, such as information that is absent from the database, the system can prompt the user for input.

Once the CSD information is compiled, the air cargo security information system can generate the CSD in a desired format. For the e-CSD format, the system can generate an electronic message in the selected or default electronic messaging format. The e-CSD can then be included in an electronic cargo message for the air cargo. The system can also validate or verify that the electronic messaging format is correct and complies with the message standards. An incorrectly formatted, or otherwise non-compliant, e-CSD can invalidate the security of the air cargo which can result in delays and decreased shipping efficiency. If the security of the air cargo is invalidated or non-acceptable due to an electronic message format error, the cargo can be required to undergo screening or inspection which can result in additional shipping costs.

FIG. 5A illustrates an example security declaration form 500. FIG. 5B illustrates an example of a method 550 of transmitting e-CSD in which the data included to the message is customized to the e-CSD form and its requirements in various countries.

### Compilation and Distribution of Air Cargo Security Information

A request for a security declaration or other security information from the air cargo security information system is generated. The generation of the request can be at the behest of a user or a larger freight and logistics system that is integrated with the air cargo security system. The air cargo security information system then retrieves the required data from a database or user input in order to generate a response to the request. Once the information is retrieved, the information is compiled as requested. The compiled information is then validated and checked by the air cargo security information system for errors and conflicts. Users are alerted or notified by the system of found errors or conflicts so that remedial action can be taken to correct the deficiencies. The air cargo security information system then outputs are response to the request in a default or selected format.

Generation of an Electronic Consignment Security Declaration (e-CSD)

A request for an e-CSD is submitted to the air cargo security information system. The request can come from a user input, an integrated or interfaced freight and logistics system or other requesting source.

Along with the request, relevant or requisite information regarding the air cargo shipment can be input into the air cargo security information system. This information can include the particulars regarding the shipment such as the contents, origin, destination, consignor information and other relevant information. The air cargo security information system can retrieve the relevant or requisite information from a database containing such information. The retrieved information can be pre-populated into a user's system interface. In an example embodiment in which the air cargo security information system is integrated with a shipping and logistics system, the air cargo security information system can retrieve the necessary air cargo information from the shipping and logistics system.

In another embodiment, the air cargo security information system can operate concurrently with a shipping and logistics system, compiling the requisite information for the e-CSD. Required, additional information regarding the air cargo can be retrieved from a connected database or system. Alternatively, a user can input, or be prompted to input, the required information into the air cargo security information system. In another embodiment, a user can input partial information or an identifying piece of information that then allows the air cargo security information system to retrieve the requisite air cargo information from a connected database or system.

The air cargo security information system can limit options and/or prompts presented to a user based on the retrieved air cargo information. This can include limiting options based on the air cargo departure laws and regulations regarding air cargo security.

Once the requisite information, or a portion thereof, regarding the air cargo shipment is retrieved or input, the air cargo security information system verifies and validates the data. If a portion of the information retrieved by or input into the air cargo security information system is missing, the system can retrieve and add additional information to complete the deficient information. This can include retrieving a consignor's trusted entity status, relevant consignor contact information and unique identifying number, a listing of the consigned goods and security statuses and the information of the user of the air cargo security information system. The additional information completes the retrieved or inputted information and can be culled from the system database, another database or another system.

If a consignor is a registered entity, the air cargo security information system can retrieve the registered entity's registration information, such as the unique identifier, the expiration of registered status and the country issuing the registered status. This information can then be included in the CSD and used during a validation and verification procedure to ensure the compliance of the air cargo with relevant laws and regulations.

Retrieved or inputted information can be compared to known information stored on the database by the air cargo security information system to validate the veracity of the retrieved or input information. The validation and verification process of the air cargo security information system cam include:

Verifying that all the requisite information for the CSD is present and/or compiled.

Verifying the accuracy of the compiled information.

Confirming the validity of a registered entity's registered status.

Validating compliance of the air cargo security with applicable laws and regulations.

The user is alerted or notified of any errors noted by the air cargo security information system during the validation and verification process. The verification and validation process can continuously operate during the retrieval or inputting of information. The continuous process can allow the system to notify or alert the user of any errors in real-time and also limit future user selections to those selections that would maintain the security status of the air cargo.

Alerted or notified system errors can include data mismatches regarding a registered entity and their status, non-compliance of prior security procedures with governing departure location laws and regulations, incomplete or missing information.

A user can be required by the air cargo security information system to acknowledge the error or alert and take an action. The allowable actions can be limited based on laws and regulations or can be a complete or partial list of available actions that can be employed to correct or account for the error.

Additionally, the system can be configured to alert a user to potential inefficiencies and/or increased economic costs associated with certain CSD inputs based on the air cargo shipment, such as a requirement that the air cargo undergo additional screening. The system can also be configured for the inverse and alert or notify a user if a more efficient or economical security option can be selected based on the laws and regulations governing the air cargo.

Once the CSD information is complete and verified as so by a user and/or the air cargo security information system, the e-CSD message can be generated. The e-CSD message can undergo further validation by the system to ensure compliance of the generated electronic message with message standards. This can include verifying that the message does not contain strings having an invalid number of characters, that the correct data codes and formatting are used for the message. The e-CSD can then be appended to an electronic cargo message or e-AWB for transmission to an air cargo receiving party such as an RA or carrier.

For consolidated shipments, the air cargo security information system can retrieve the security information for each of the individual shipments that comprise the consolidated shipment when preparing the CSD. During the validation and verification process, each of the individual shipments can be checked for compliance with applicable laws and regulations. If an individual shipment fails validation, the system can alert the user to the situation and highlight the deficiency, allowing the user to select from a list of available options for correcting the deficiency. In an example embodiment, an individual shipment, of the consolidated shipment, can have come from a non-trusted entity. The individual shipment is not considered secure and the inclusion of the individual shipment in the consolidated shipment can invalidate the security status of the entire shipment. This can require that the entire shipment be screened or inspected before it can be considered secure. The system can notify the user of these potential situations, allowing the user to remove the individual shipment from the consolidated shipment. The individual shipment can then be included in a further consolidated shipment where the economic and efficiency impact of the unsecured status minimally affects the consolidated shipment.

### External Access to Air Cargo Security Information System

External access to the system database and/or the cargo security information system can be configured by a system administrator. The external access can allow others to update relevant information regarding the air cargo security. Access to the system and/or database(s) can include a permission hierarchy, allowing users limited access and permissions to view and write data regarding air cargo. In an example embodiment, consignors can be allowed to input air cargo information such as the contents and identifying consignor information, agents can input similar information. Consignors and agents can also be allowed permissions to update their information regarding registered entity status and other necessary or desired information.

A further feature can include the ability for entities involved with the transport of the air cargo to input anomalies or notations regarding the security of the air cargo during transit. An example could include the overland travel of an air cargo shipment from a KC's location to an RA, if a potential breach in the air cargo security status occurred during transit, the overland carrier can input a notation or alert into the system notifying a user that the security of air cargo may have been compromised and the air cargo should be considered an unsecured cargo at this point. Other entities and users can be granted access to the air cargo security information system as necessary or desired by a system administrator or other who is qualified to grant such permissions.

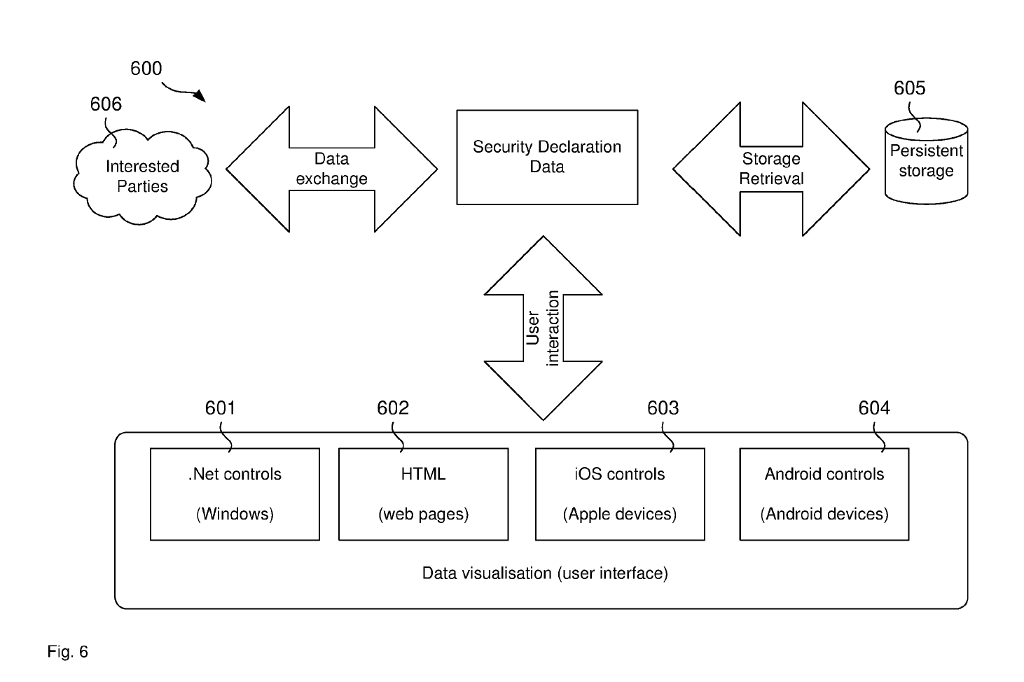

FIG. 6 depicts the embedded form and the visualization of the data to the user. The form can be displayed using various technologies, including but not limited to .NET 601 WinForm user control to display this information in CargoWise One or use XAML for GLOW or HTML 602 to display an information in a web page or iOS for iPhone 603 or Android controls for Android devices 604. This is an electronic form with information pre-populated with the data stored within a database 605 that may be an internal database or electronically retrieved from an external data source and partially available for edit by an operator. The data captured on the form can be persisted in the database 605 and stored for later retrieval. The data can be validated for accuracy and legitimacy to satisfy security compliance requirements. The validated data can be printed or electronically sent to an interested party 606 (this being an airline or any other external party's computer system or an internal data buss for usage by other logistics components/modules of our software) in a format required by a receiving application.

Other features disclosed herein include that the data can be defaulted from another data available on the same system or pulled from another data source, the data can be changed by a user, the data can be persisted in a database and stored there for later retrieval and the data can be electronically sent to an interested party (being an airline, a trading partner system, an internal data buss). For that purpose XML can be used but other rendering languages could be used for other formats such as JSON. Also, the data is validated against relevant business rules to ensure compliance. User can receive a notification about any broken rules.

Accordingly, among other methods and systems disclosed herein, a shipping security method as disclosed can include receiving a request for information about at least one entity in a group of trusted entities, where at least one entity is associated with a cargo shipment and determining if the trusted entity meets requirements recognized by the jurisdiction of the origin or transshipment location of the cargo shipment. At each transit point along a transit pathway for the cargo shipment, verifying that the cargo shipment is secure and if the cargo shipment is determined to be unsecure, generate an alert to inspect the goods before permitting the cargo shipment to be moved to a next transit point.

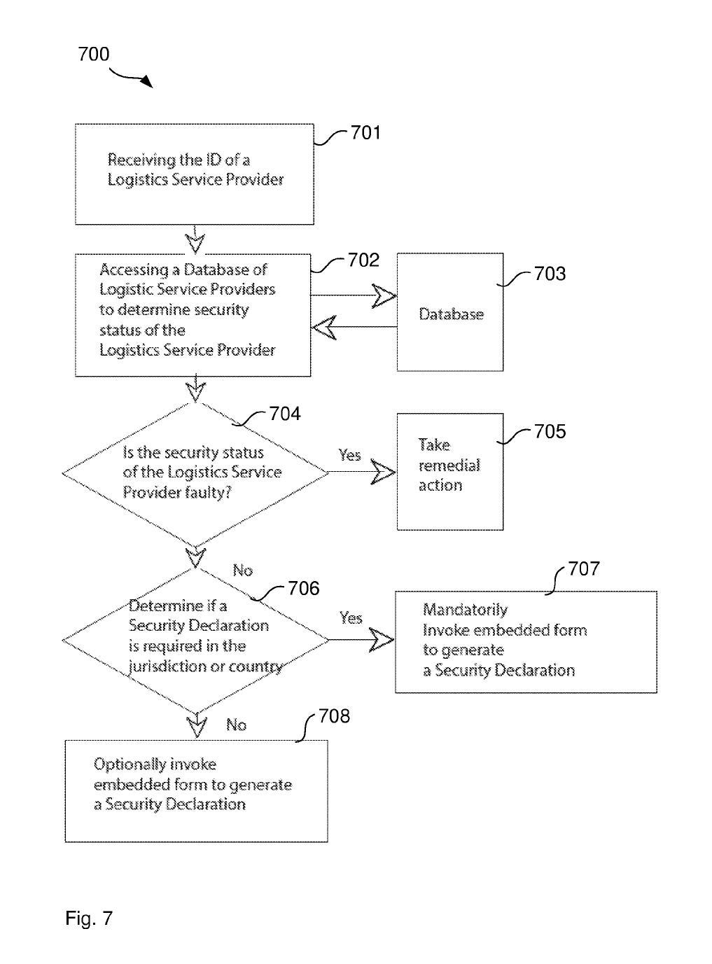

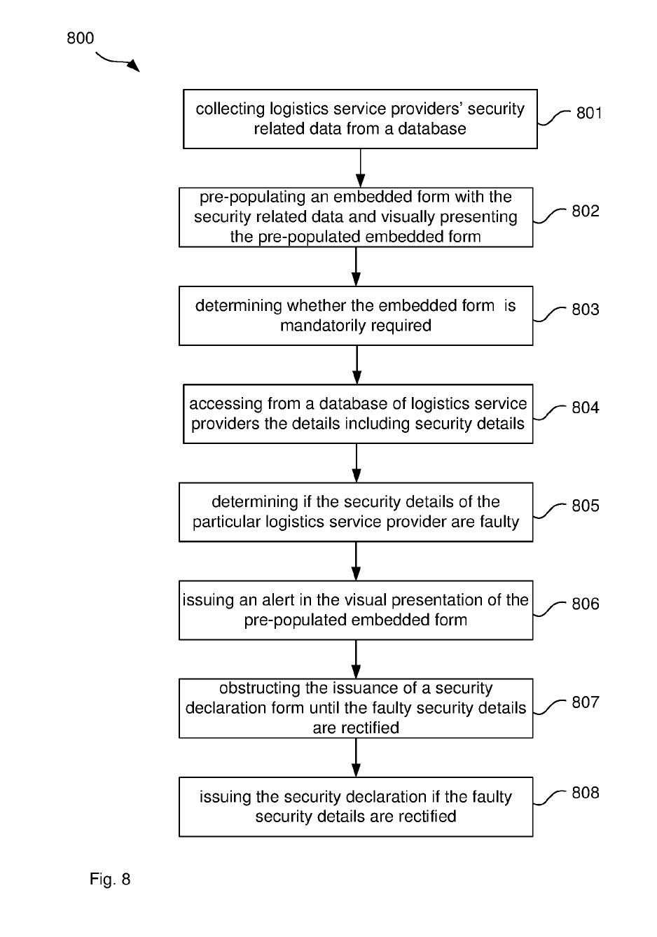

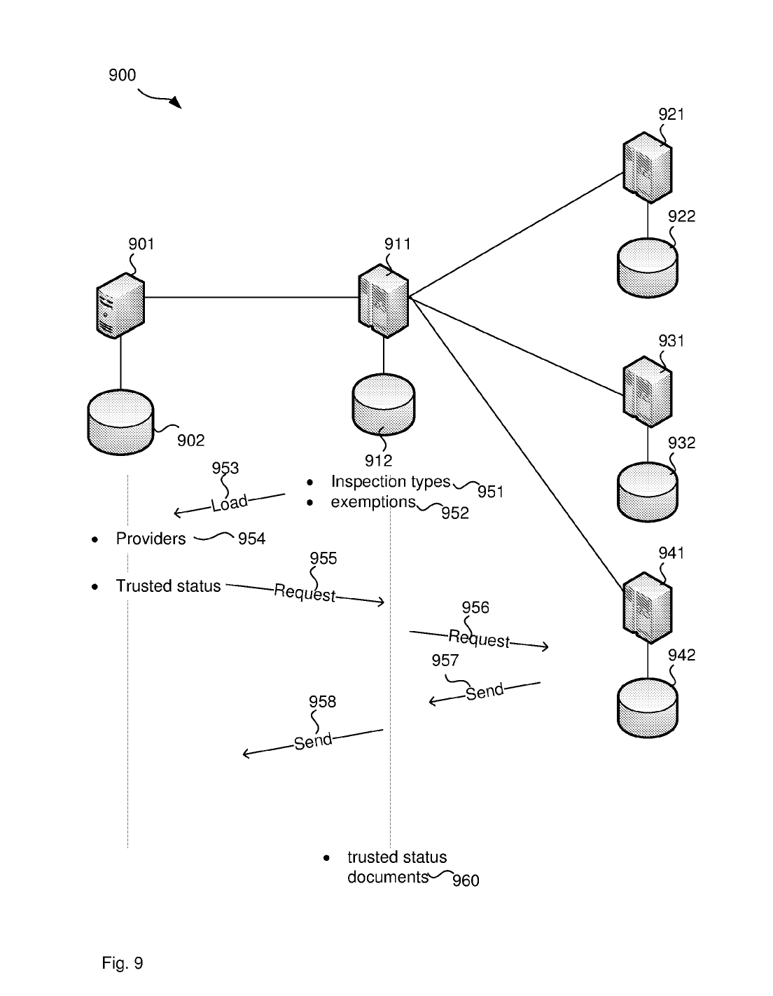

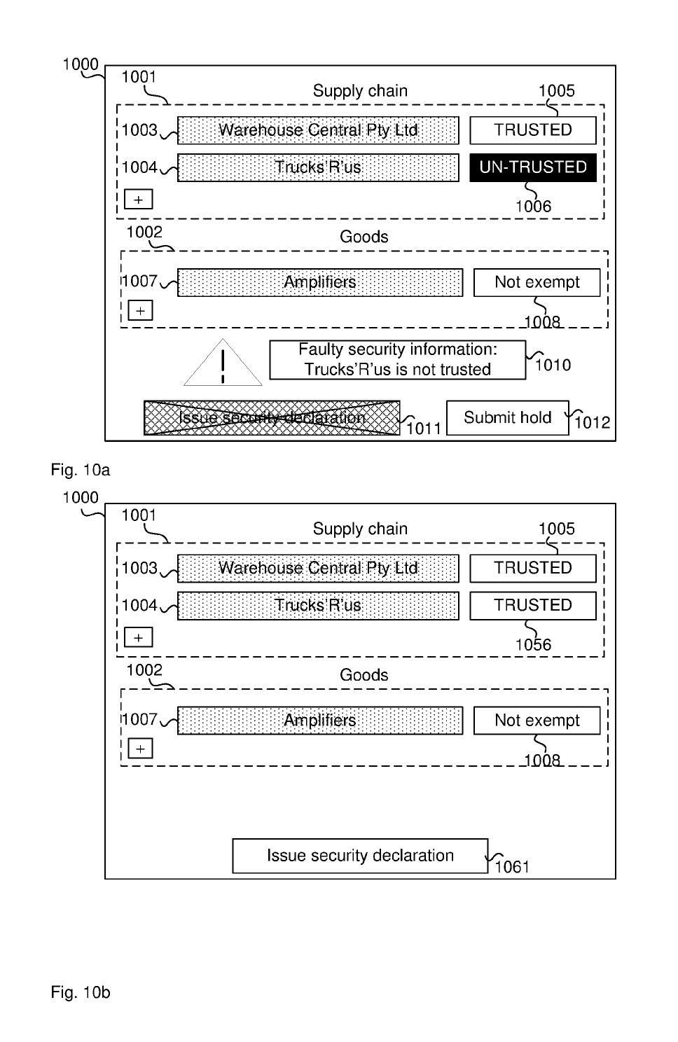

FIG. 7 is a flowchart of a disclosed method 700 including receiving 701 the ID of a logistics service provider and accessing 702 a Database 703 of Logistic Service Providers to determine security status of the Logistics Service Provider. Method 700 then determines 704 whether the security status of the Logistics Service Provider is faulty. If the security status is faulty, method 700 comprises taking remedial action 705. If the security status is not faulty, method 700 determines 706 if a Security Declaration is required in the jurisdiction or country. If it is required, method 700 continues by mandatorily invoking 707 embedded form to generate a Security Declaration. If it is not required, method 700 optionally invokes 708 embedded form to generate a security declaration.

Method 700 may comprise collecting security related data from a database and visually presenting it in an embedded form into a system of freight forwarding, the embedded form being mandatorily required depending upon the jurisdiction of the origin or transhipment location of a consignment, wherein the embedded form includes available fields for identifying logistics service providers who deliver goods to freight forwarders, logistics service providers having associated security details. If the form is mandatorily required, accessing from a database of logistics service providers the details including security details of at least one particular logistics service provider associated with the particular consignment, and providing the security details of the particular logistics service providers to the form and if the security details of the particular logistics service provider associated with a particular consignment security details are faulty, issuing an alert.

FIG. 8 illustrates a process 800 as performed by processor 104 of freight forwarding system 101 in FIG. 1, for example, for security validation of a consignment for determining whether to issue a security declaration form. The process 800 commences by processor 104 collecting 801 logistics service providers' security related data from database 102. Processor 104 then pre-populates 802 an embedded form of the logistics system 101 with the security related data and visually presents the pre-populated embedded form of a system of freight forwarding on a user's system interface 106.

Processor 104 also determines 803 whether the embedded form is mandatorily required by determining the jurisdiction of the origin or transhipment location of a consignment. The embedded form includes available fields for security details, such being pre-populated for identifying logistics service providers who deliver goods to freight forwarders, logistics service providers having associated security details. If the form is mandatorily required, accessing 804 from database 102 of logistics service providers the details including security details of at least one particular logistics service provider associated with the particular consignment, and providing the security details of the particular logistics service providers to the form.

Next, processor 104 determines 805 if the security details of the particular logistics service provider associated with a particular consignment security details are faulty. Faulty may be at least one of an untrusted rating, mal-formatted, missing or expired trusted entity identifier or incorrect or missing security inspection method or exemption. If this is the case, processor 104 issues 806 an alert in the visual presentation of the pre-populated embedded form. If in determining whether an embedded form is mandatorily required, the determination is that the embedded form is mandatory, processor 104 obstructs 807 the issuance of a security declaration form until the faulty security details are rectified. Finally, processor 104 issues 808 the security declaration if the faulty security details are rectified.

FIG. 9 illustrates a logistics computer network 900 as one example implementation of the methods described herein. Logistics computer network 900 comprises a client computer 901 connected to a client database 902, a logistics server 911 connected to a server database 912 and multiple local jurisdiction data provider computer systems 921, 931, 941 connected to respective local jurisdiction databases 922, 932, 942.

In this example, the server database 912 stores data related to inspection types 951 and exemptions 952. For example, some jurisdictions accept X-Ray inspections while others require manual inspection. Further, some jurisdictions exempt certain goods, such as diplomatic mail, from security inspections. Server 911 loads 953 this data related to inspection types and exemptions onto client database 902 by sending the data to the client 901. Client 901 executes a client software program that allows the remote update of the client database 902 and stores the data in relation to the inspection types and exemptions on client database 902.

Client database 902 further stores data related to providers 954 involved in the supply chain, such as provider name and address. Providers may include warehouse operators and truck companies that transport the goods from the warehouse to the airport. In this example, the provider data is editable by the client 901 which allows the client 901 to adjust their supply chain according to their particular needs. In order to issue the security declaration form, client computer system 901 determines the trusted status of each of the providers. In this example, the trusted status is set by a third party and may change frequently Therefore, the trusted status is not stored on client database and/or is not editable by the client 901.

Instead, client computer system sends a request message 955 for the trusted status to the server 911. The server 911 determines the jurisdiction of the provider and sends the request 956 to the local jurisdiction data provider 941. The local jurisdiction data provider 941 queries its database 942 and returns the trusted status 957 to the server 911. The server may maintain a trusted status table on database 912 to reduce the number of queries to the local jurisdiction data providers 921, 931 and 941. In that case, the server 911 updates the server database 912 and finally sends the trusted status 958 to the client 901. When the server 911 receives a trusted status request, server 911 checks the details including the address details against the entries in database 912 and returns the corresponding trusted status or an error message if the status is not trusted or the provider could not be found in server database 912 or in any of the local jurisdiction databases 922, 932, 942.

In one example, server 911 allows the providers to upload trusted status documents 960 and stores the trusted status documents 960 in server database 912. This way, server 911 can extract information from the documents, such as the provider identifier and expiry date of the trusted status certificate. Server 911 can then send a renewal notice to the providers such that their trusted status is maintained. This allows automatic processing of trusted status requests, in particular where the requirements are highly heterogeneous. For example, some jurisdictions issue a trusted status identifier whereas other jurisdictions use the registered business number as an identifier. Of course, the business number is also issued to non-trusted providers which creates a further difficulty that is addressed by the systems and methods proposed herein.

FIG. 10a illustrates an example embedded form 1000 of a logistics system in the case of faulty security information. The embedded form comprises a supply chain area 1001 and a goods area 1002. The supply chain area 1001 comprises a first input field 1003 to allow a user to input first logistics provider details. In this example the user has provided the name of a warehouse operator. The supply chain area further comprises a second input field 1004 to allow the user to input second logistics provider details. In this example the user has provided the name of a truck company. More input fields may be displayed to allow the user to define more complex supply chains. In FIG. 10a the editable fields are indicated by a shading. The user may also be allowed to change the details, such as address, of the providers or select from a list of previous or stored providers, such as a drop-down list.

The logistics system collects the logistics service providers' security related data from database 912 and pre-populates the embedded form 1000. In this example, the logistics system pre-populates the security status of the providers. In particular, a status of the first provider 1003 is ‘trusted’ as pre-populated at item 1005 while a status of the second provider 1004 is ‘un-trusted’ at item 1006. In the goods area 1002 there is an input field 1007 to provide details of goods to be shipped. The logistics system automatically pre-populates the form 1000 with the exemption status 1008 (in this case ‘not exempt’). As described above, the logistics system determines whether the embedded form or security declaration is mandatorily required. The embedded form 1000 may comprise an input field to provide the applicable jurisdiction or the system may determine the jurisdiction from the providers' address details or the shipment departure airport.

In this case, the form is required since the amplifiers specified at goods input field 1007 are not exempt for this jurisdiction. However, the security details of Trucks'R'us are faulty since this company is un-trusted. Therefore, the system issues an alert 1010, which may comprise information on which security information is faulty. The system further obstructs the issuance of the security declaration by de-activating a submit button 1011 or by evaluating a test clause that tests for the absence of faults. However, the user may have the option to save the form content, such as by clicking a submit hold button 1012. This causes the system to store the data and hold the issuance of the security declaration form until the faulty security information is rectified.

FIG. 10b illustrates an example embedded form 1050 of a logistics system in the case of rectified security information. In this example, the company Trucks'R'us have renewed their trusted status and as result, the trusted status indication 1056 is now valued ‘TRUSTED’, the alert 1010 of FIG. 10a has disappeared and the button for issuing the security declaration 1061 is now active. The user can now click on button 1061 to issue the security declaration. Alternatively, if the form was on hold, the system can automatically issue the security declaration without further user input since the data for the security declaration form is available.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A process of a freight forwarding system for security validation of a consignment for determining whether to issue a security declaration form, comprising:
collecting logistics service providers' security related data from a database;
pre-populating an embedded form of the logistics system with the security related data and visually presenting the pre-populated embedded form of a system of freight forwarding on a user's system interface;
determining whether the embedded form is mandatorily required by determining a jurisdiction of an origin or transhipment location of a consignment, wherein the embedded form includes available fields for security details, such being pre-populated for identifying logistics service providers who deliver goods to freight forwarders, logistics service providers having associated security details;
if the form is mandatorily required, accessing from a database of logistics service providers the details including security details of at least one particular logistics service provider associated with the particular consignment, and providing the security details of the particular logistics service providers to the form;
determining if the security details of the particular logistics service provider associated with a particular consignment security details are faulty, wherein faulty is at least one of an untrusted rating, mal-formatted, missing or expired trusted entity identifier or incorrect or missing security inspection method or exemption,
issuing an alert in the visual presentation of the pre-populated embedded form if it is determined that the security details are faulty;
if in determining whether an embedded form is mandatorily required, the determination is that the embedded form is mandatory, obstructing the issuance of a security declaration form until the faulty security details are rectified; and
issuing the security declaration if the faulty security details are rectified.

2. The process of claim 1, further comprising:
if the form is not mandatorily required, and instructions are received to generate the form, accessing from a database of logistics service providers, the details including security details of at least one particular logistics service provider associated with the particular consignment, and providing the security details of the particular logistics service provider to the form; and
if the security details of a particular logistics service provider associated with a particular consignment security details are faulty, issuing an alert.

3. The process of claim 1, further comprising:
if the security details of one or more particular logistics service providers are not faulty, generating the form to electronically dispatch it with a way-bill or any other logistics documents.

4. The process of claim 1, further comprising:
if the security details of one or more particular logistics service providers are faulty, issuing an alert stipulating security inspection process or defining grounds for security inspection exemption of the goods by one of the methods recognised by the jurisdiction of the origin or transhipment location of the consignment and recording the outcome on the form.

5. The process of claim 1, further comprising:
if the security details of one or more particular logistics service providers are not faulty or appropriate security measures are taken and recorded on the form, generating the form to electronically dispatch it with a way-bill or any other logistics documents.

6. A freight forwarding system for security validation of a consignment to determine whether to issue a security declaration form, comprising:
means for collecting logistics service providers' security related data from a database and means for providing a pre-populated embedded form into a system of freight forwarding and visually presenting the embedded form on a user's system interface, the embedded form being mandatorily required depending upon a jurisdiction of an origin or transhipment location of a consignment, wherein the embedded form includes available fields for identifying logistics service providers who deliver goods to freight forwarders, logistics service providers having associated security details;
if the form is mandatorily required, means for accessing from a database of logistics service providers the details including security details of at least one particular logistics service provider associated with the particular consignment, and providing the security details of the particular logistics service providers to the form;
if the security details of the particular logistics service provider associated with a particular consignment security details are faulty, wherein faulty is at least one of an untrusted rating, mal-formatted, missing or expired trusted entity identifier or incorrect or missing security inspection method or exemption, means for issuing an alert,
means for obstructing the issuance of a security declaration form until the faulty security details are rectified;
if in determining whether an embedded form is mandatorily required, the determination is that the embedded form is mandatory, means for obstructing the issuance of a security declaration form until the faulty security details are rectified; and
issuing the security declaration if the faulty security details are rectified.

7. (canceled)

8. (canceled)

9. A system for security validation of a consignment, comprising:
means for providing an embedded form into a system of freight forwarding, the embedded form being mandatorily required depending upon a jurisdiction of an origin or transhipment location of a consignment, wherein the embedded form includes available fields for identifying logistics service providers who deliver goods to freight forwarders, logistics service providers having associated security details;
if the form is mandatorily required, means for accessing from a database of logistics service providers the details including security details of at least one particular logistics service provider associated with the particular consignment, and providing the security details of the particular logistics service providers to the form; and
if the security details of the particular logistics service provider associated with a particular consignment security details are faulty, means for issuing an alert.

10.-17. (canceled)

18. The system of claim 9 wherein the consignment travels on a transit pathway, and wherein at each transit point along a transit pathway for the cargo shipment, further comprising:
means for verifying that the cargo shipment is secure at each transit point.

19. A supply chain security system for security validation of a cargo shipment including an application capable of running on a remote computer or device having an embedded security declaration form to facilitate jurisdictionally required security compliance requirements, the security declaration form being mandatorily required depending upon a jurisdiction of an origin and/or a transit point of the consignment, wherein the embedded security declaration form includes available fields for identifying trusted entities having associated security details, for a security inspection code and for an exemption code, comprising:
a system database remote to the remote computer or device that stores information compiled about trusted entities;
a processor configured to:
determine whether the embedded security declaration form is mandatorily required of the jurisdiction;
if a security declaration form is mandatorily required by the jurisdiction, automatically generate the application's embedded security declaration form;
query the database about whether an entity associated with a cargo shipment is a trusted entity wherein a trusted entity has an up-to-date registration;
validate if the trusted entity associated with the cargo shipment meets security compliance requirements of the jurisdiction of the origin or a transshipment location of the cargo shipment;
stipulate by an alert a security inspection requirement or provide an exemption from a security inspection requirement for the cargo shipment based at least in part upon a result of the query about whether the entity is a trusted entity located in the database and validated for the jurisdiction of the origin or a transshipment location of the cargo shipment; and
if the entity is a trusted entity and meets the security compliance requirements, in the embedded security declaration form, populate and visually present the form on a user's system user interface to include security details of the entity wherein an exemption code instead of an security inspection code is input to the security declaration form.

20. The system of claim 19 wherein the processor further is configured to:
receive multiple shipment data relating to multiple cargo shipments wherein the multiple cargo shipments are made up of one or more portions of the cargo shipment;
correlate multiple shipment data relating to at least some portions of the cargo shipment based upon whether the entities are trusted entities and whether a security declaration form has been issued for one or more of the multiple cargo shipments; and
compile the multiple shipment data relating to the multiple cargo shipments into data of a consolidated shipment at least based in part on the correlated multiple shipment data.

21. The system of claim 19, wherein the processor is further configured to generate a security declaration form before the cargo shipment is delivered to another entity in the supply transit pathway.

22. The system of claim 19, wherein the security declaration form is customized for a geographic location of the user.

23. The system of claim 19, wherein the processor is further configured to create a chain of custody of the cargo shipment between each of the transit points along the transit pathway.

24. A method of a supply chain security system for security validation of a cargo shipment in a transit pathway, the system including a database that stores information compiled about entities including an application capable of running on a remote computer or device having an embedded security declaration form to facilitate jurisdictionally required security compliance requirements, the security declaration form being mandatorily required depending upon a jurisdiction of an origin and/or a transit point of the consignment, wherein the embedded security declaration form includes available fields for identifying entities having associated security details, for a security inspection code and for an exemption code, the system including a system database remote to the remote computer or device that stores information compiled about trusted entities, the method comprising:
determining whether the embedded security declaration form is mandatorily required of the jurisdiction;
if a security declaration form is mandatorily required by the jurisdiction, automatically generating the application's embedded security declaration form;
querying the database about whether an entity associated with a cargo shipment is a trusted entity wherein a trusted entity has an up-to-date registration;
validating if the trusted entity associated with the cargo shipment meets security compliance requirements of the jurisdiction of the origin or a transshipment location of the cargo shipment to facilitate security compliance with the jurisdiction of a location of an embedded form issuer;
stipulating by an alert a security inspection requirement or provide an exemption from a security inspection requirement for the cargo shipment based at least in part upon a result of the query about whether the entity is a trusted entity located in the database and if the entity is validated as meeting security compliance requirements recognized by the jurisdiction of the origin or a transshipment location of the cargo shipment;
if the entity is a trusted entity and meets the security compliance requirements, in an embedded form, populating and visually presenting the form on a user's system user interface to include security details of the entity wherein an exemption code instead of an inspection code is stated on the security declaration form.

25. The method of claim 24 further comprising:
receiving multiple shipment data relating to multiple cargo shipments wherein the multiple cargo shipments are made up of one or more portions of the cargo shipment;
correlating multiple shipment data relating to at least some portions of the cargo shipment based upon whether the entities are trusted entities and whether a security declaration form has been issued for one or more of the multiple cargo shipments; and
compiling the multiple shipment data relating to the multiple cargo shipments into data of a consolidated shipment at least based in part on the correlated multiple shipment data.

26. The method of claim 24, further comprising generating a security declaration form for at least one of the origin or the transit points along the transit pathway.

27. The method of claim 24, further comprising customizing the security declaration form for a geographic location of the user.

28. The method of claim 24, further comprising creating a chain of custody of the cargo shipment between each of the transit points along the transit pathway.
